(19) United States
(12) Patent Application Publication
(10) Pub. No.: US 2002/0145875 A1
(43) Pub. Date: Oct. 10, 2002

(54) Compact water-cooled multi-kilowatt lamp

(75) Inventors: Roy D. Roberts, Hayward, CA (US); John Kiss, San Jose, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: PerkinElmer Optoelectronics N.C., Inc.

(21) Appl. No.: 09/835,956

(22) Filed: Apr. 10, 2001

(51) Int. Cl. F21V 29/00

(52) U.S. Cl. 362/294; 362/264; 362/293; 362/276

(57) ABSTRACT

A water-cooled arc lamp comprises a two concentric cylindrical glass envelopes. A circulation of high purity water and ethylene glycol is maintained between the envelopes which form a water jacket. Such water mixture is highly transparent to light at the relevant wavelengths. A pair of anode and cathode electrodes in a xenon atmosphere is disposed inside the inner envelope. The cooling water mixture is pumped at a sufficiently high flow rate to prevent water from boiling at the glass to water surfaces and thereby suppress bubbles. A safety interlock flow switch is able to interrupt arc lamp operating power if the water circulation fails. An external parabolic reflector compensates for the light path diffraction distortions that occur as the light passes through the water jacket. In alternative embodiments, the water mixture is color doped to color filter the output light.

### BACKGROUND OF THE INVENTION

1. Field of the Invention

The invention relates generally to arc lamps, and specifically to water-cooled lamps that can be operated at high extreme power levels and that are physically much smaller than conventional types of the same power.

2. Description of the Prior Art

Short-arc lamps provide intense point sources of light that allow light collection in reflectors for applications in medical endoscopes, instrumentation and video projection. Also, short-arc lamps are used in industrial endoscopes, for example in the inspection of jet engine interiors. More recent applications have been in color television receiver projection systems and dental curing markets.

A typical short-arc lamp comprises an anode and a sharp-tipped cathode positioned along the longitudinal axis of a cylindrical, sealed concave chamber that contains xenon gas pressurized to several atmospheres. U.S. Pat. No. 5,721,465, issued Feb. 24, 1998, to Roy D. Roberts, describes such a typical short-arc lamp.

Conventional short-arc lamps have reached power levels of five kilowatts already, but such lamps are relatively large and expensive to produce. A typical five kilowatt quartz lamp is three inches in diameter and is sixteen inches long. Prior art quartz lamps also have a relatively short life.

### SUMMARY OF THE PRESENT INVENTION

It is therefore an object of the present invention to provide a multi-kilowatt short-arc lamp that is more compact than conventional designs.

It is another object of the present invention to provide a multi-kilowatt short-arc lamp that separates out and disposes of the infrared heat generated.

Briefly, a water-cooled arc lamp embodiment of the present invention comprises two concentric cylindrical glass envelopes. A circulation of high purity water and ethylene glycol is maintained between the envelopes which form a water jacket. Such water mixture is highly transparent to light at the relevant wavelengths. A pair of anode and cathode tungsten electrodes in a xenon atmosphere is disposed inside the inner envelope. The cooling water mixture is pumped under pressure through the water jacket to increase the boiling point of the water mixture and thereby suppress bubbles. A safety interlock flow switch is able to interrupt arc lamp operating power if the water circulation fails. An external parabolic reflector compensates for the light path diffraction distortions that occur as the light passes through the water jacket. In alternative embodiments, the water mixture is color doped to color filter the output light.

An advantage of the present invention is that a tubular-sapphire arc lamp is provided that is more compact than non-watercooled lamps of similar power levels.

Another advantage of the present invention is that a tubular-sapphire arc lamp is provided that is simple in design.

These and other objects and advantages of the present invention will no doubt become obvious to those of ordinary skill in the art after having read the following detailed description of the preferred embodiments which are illustrated in the drawing figures.

### IN THE DRAWINGS

FIG. 1 is cross sectional view of a water-cooled short-type arc lamp in a first embodiment of the present invention;

FIG. 2 is cross sectional view of a water-cooled short-type arc lamp in a second embodiment of the present invention;

FIG. 3 is a cross section view illustrating a water-cooled arc-lamp illumination system embodiment of the present invention; and

FIG. 4 is cross sectional view of a water-cooled short-type arc lamp in a third embodiment of the present invention that includes glass rods that help circulate cooling water to the distal end of the lamp.

### DETAILED DESCRIPTION OF THE PREFERRED EMBODIMENT

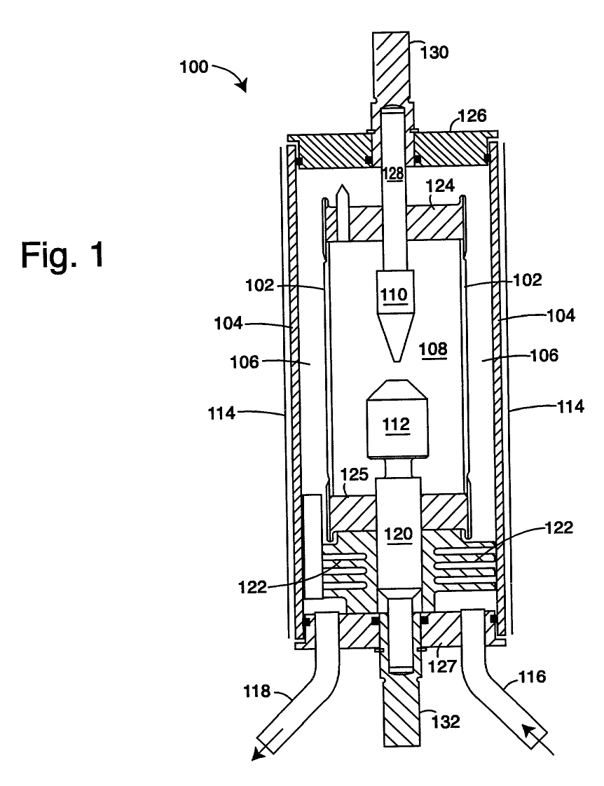

FIG. 1 illustrates a xenon short-arc lamp embodiment of the present invention, and is referred to herein by the general reference numeral 100. The xenon arc lamp 100 comprises an inner hollow cylinder of glass 102, an outer hollow cylinder of glass 104 in which the inner cylinder is coaxially disposed, a water jacket 106 disposed between the inner and outer cylinders, a xenon atmosphere 108 disposed within the inner cylinder, and a cathode 110 and anode 112 short-arc pair of electrodes disposed coaxially in the inner cylinder and also in the xenon atmosphere. A circulation of liquid, transparent coolant is maintained in the water jacket to cool the heat dissipated during operation by the cathode and anode short-arc pair of electrodes.

A mixture of deionized water and ethylene glycol is disposed and able to circulate within the water jacket 106. Such mixture naturally filters out ultraviolet (UV) light that would otherwise be output by the lamp. An infrared (IR) filter coating 114 is preferably applied to the outside surfaces of the hollow cylinder of glass 104 to suppress IR output.

The water jacket 106 supports a pressurization of the coolant to 30-90 PSI to allow for a minimum flow of four gallons per minute (GPM) that is required to provide for adequate heat transfer for a five kilowatt lamp 100. A pair of liquid-coolant supply 116 and return 118 ports are provided at the anode end of the water jacket near a stem 120 of the anode electrode.

A radially finned heat exchanger 122 receives circulating liquid coolant, and is coaxially disposed about the base stem 120. Any number of fin designs are appropriate, e.g., radial fins as shown, longitudinal fins, turbine-blade type, etc. The object is to couple as much heat as possible out of the anode stem 120 and heatsink 122 into the circulating coolant. Another object is to spread the heat as uniformly as possible to reduce thermal distortions and stresses.

A set of four bases 124-127 are provided at each end of each of the inner and outer cylinders and provide for the separate containment of the water jacket 106 and the xenon atmosphere 108. Plugs 124 and 125 are typically comprised of kovar and are brazed to an inner cylinder 102 of sapphire glass. The respective coefficients of thermal expansion are therefore closely matched and an appropriate seal can be maintained over the operational life of the lamp. Bases 126 and 127 are made of metal and are sealed with rubber O-rings against pressurized water leaks against the outer cylinder 104 of quartz glass. Bases 124 and 126 are penetrated by a cathode stem 128 of the cathode electrode. This provides for a first electrical connection 130 to operate the lamp. Conversely, bases 125 and 127 are penetrated by the anode stem 120, and this provides for a second electrical connection 132 to operate the lamp.

In commercial production, it is preferable to construct lamp 100 such that the inner cylinder 102 and all its working parts inside can be replaced as a single assembly. The bases 126 and 127 are therefore made to be removable from both the outer cylinder 104 and the electrode stems 120 and 128.

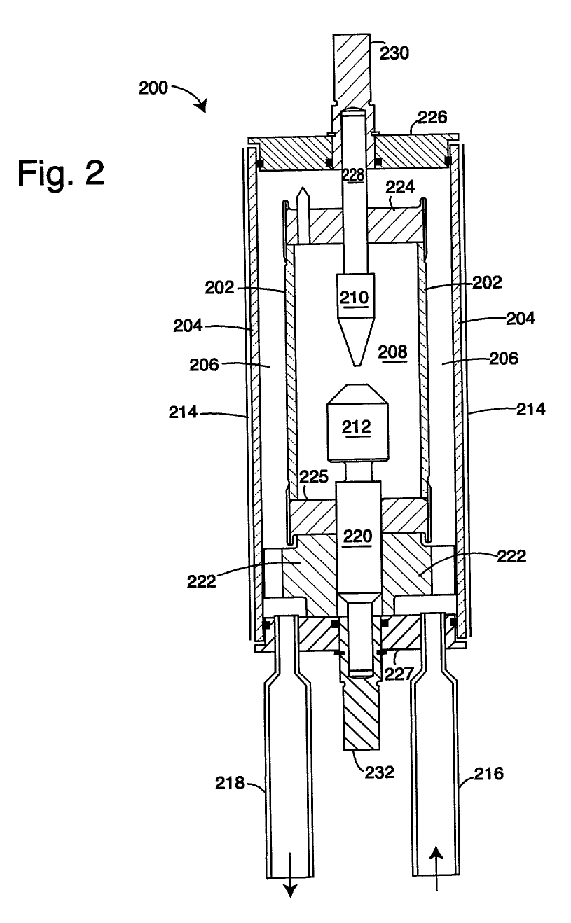

FIG. 2 illustrates a xenon short-arc lamp embodiment of the present invention, and is referred to herein by the general reference numeral 200. Lamp 200 is similar to lamp 100 (FIG. 1), and differs principally in the orientation of the internal heatsink fins and the coolant piping. The xenon arc lamp 200 comprises sapphire-glass inner envelope 202, a quartz-glass outer envelope 204 in which the inner envelope is coaxially disposed, a water jacket 206 disposed between the inner and outer envelopes 202 and 204, a xenon atmosphere 208 disposed within the inner envelope, and a cathode 210 and anode 212 pair of short-arc electrodes disposed coaxially in the inner envelope, and also in the xenon atmosphere. A circulation of liquid, transparent coolant is maintained in the water jacket to cool the heat dissipated during operation by the cathode and anode short-arc pair of electrodes. A hot-mirror coating 214 is preferably applied to the outside surfaces of the quartz glass envelope 204 to suppress IR output.

In one embodiment of the present invention that appears to be economically producible, the sapphire-glass inner envelope 202 was 1.5″ in diameter and 2.697″ long. The quartz-glass outer envelope 204 was 2.185″ in diameter and 5.205″ long. The cathode 210 and anode 212 electrodes were substantially comprised of tungsten. A coolant mixture of deionized water and ethylene glycol (20% volume) filled and circulated within the water jacket 206. The coolant was pressurized within the water jacket 206 to prevent boiling and concomitant bubbles, e.g., to 60-90 PSI. A minimum flow of four gallons per minute (GPM) was maintained for a five kilowatt lamp 200.

A pair of liquid-coolant supply 216 and return 218 ports are provided at the anode end of the water jacket near a stem 220 of the anode electrode. These are shown with straight in approaches that neck down to smaller diameters as they pass into the lamp. A longitudinally finned heat exchanger 222 receives circulating liquid coolant, and is coaxially disposed about the base stem 220.

A set of four bases 224-227 provided at each end of each of the inner and outer envelopes and providing for the separate containment of the water jacket 206 and the xenon atmosphere 208. Bases 224 and 225 are typically comprised of kovar and are fused to an inner envelope 202 of sapphire glass. The respective coefficients of thermal expansion are therefore closely matched and an appropriate seal can be maintained over the operational life of the lamp. Bases 226 and 227 are made of metal and are sealed with rubber O-rings against pressurized water leaks against the outer envelope 204 of quartz glass. Bases 224 and 226 are penetrated by a stem 228 of the cathode electrode. This provides for a first electrical connection 230 to operate the lamp. Conversely, bases 225 and 227 are penetrated by the anode stem 220, and this provides for a second electrical connection 232 to operate the lamp.

In order to reduce operational costs, it is preferable to construct lamp 200 such that the inner envelope 202 and all its working parts inside can be replaced as a single assembly, e.g., by remanufacturing. The bases 226 and 227 are therefore made to be removable by the factory from both the outer envelope 204 and the electrode stems 220 and 228.

The bare lamp assembly, comprising the inner sapphire glass envelope 202, the electrodes 210 and 212, and the kovar bases 224 and 225, is therefore preferably all bonded together. The stems 230 and 232 can be threaded so nuts or other fasteners can be used to retain the outside base ends 225 and 226 against the expansion pressures generated inside the water jacket 206.

Lamps 100 and 200 can be scaled up and operated at much higher power levels, e.g., ten, fifteen, and twenty kilowatts.

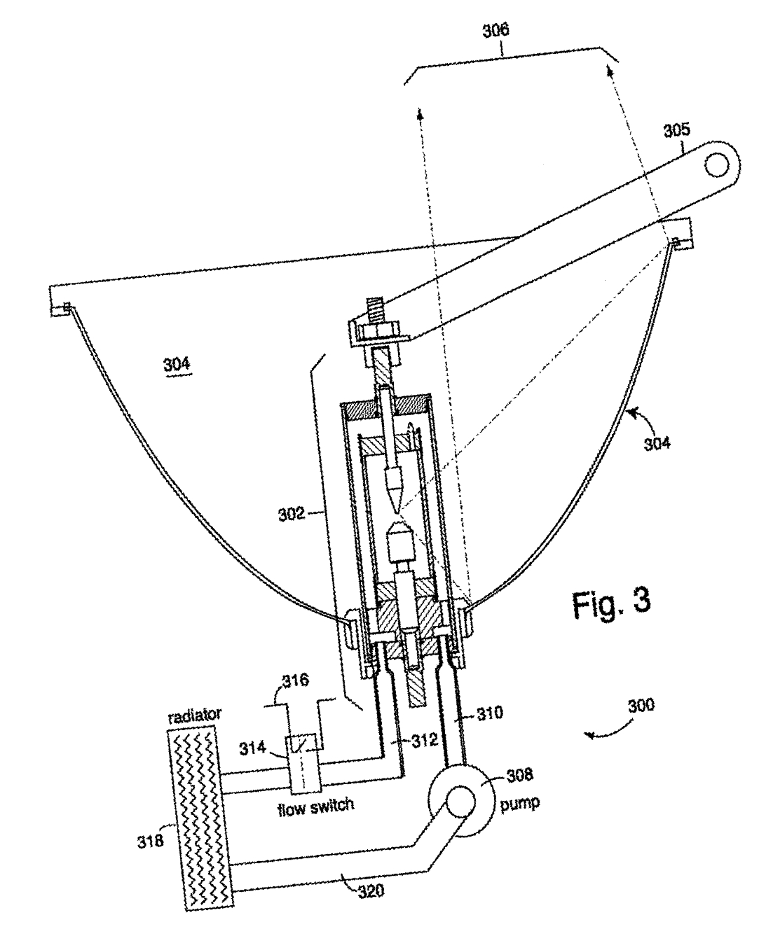

FIG. 3 represents an illumination system embodiment of the present invention, and is referred to herein by the general reference numeral 300. The system 300 comprises a water-cooled arc lamp 302 that is essentially equivalent to lamp 100 (FIG. 1) and lamp 200 (FIG. 2). As with all these lamps, the several diffraction interfaces within the lamp between sapphire glass, liquid coolant, quartz glass, and air longitudinally distort the output light. A near-parabolic reflector 304 produces a conventional light-output beam 306 from lamp 302 by correction for the internal lamp distortions. Of course, the reflector can be shaped to bring either near or infinity focus for different applications. But the common theme in all such reflectors 304 will be to correct for the internal distortions of the coaxially disposed water-cooled lamp 302.

A water pump 308 is used to force a circulation of liquid coolant into a supply pipe 310. Heated coolant is collected in a return pipe 312 and operates a flow switch 314. An electrical circuit 316 can be used to interrupt operating power to the lamp 302 whenever the flow rate is too slow or the temperature is too high. A radiator 318 is used to cool the liquid coolant, e.g., in a heat transfer to forced air. A radiator return line 320 completes the cooling circuit back to the pump 308. Such cooling circuit is preferably pressurized to at least sixty PSI, and a pressure relieve valve common to boilers and water heaters may be necessary for safe operation.

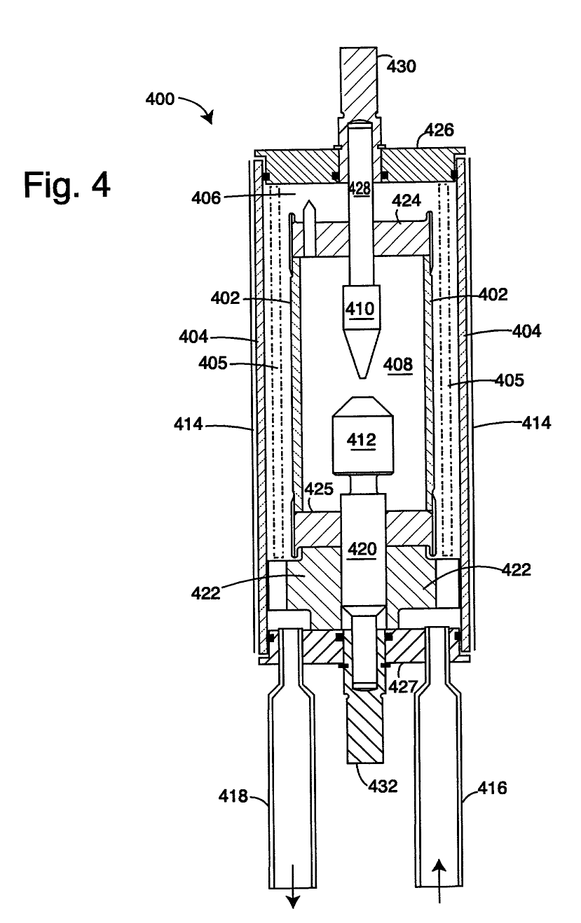

FIG. 4 illustrates a xenon short-arc lamp embodiment of the present invention, and is referred to herein by the general reference numeral 400. Lamp 400 is similar to lamps 100 (FIG. 1) and 200 (FIG. 2). The xenon arc lamp 400 comprises sapphire-glass inner envelope 402, a quartz-glass outer envelope 404 in which the inner envelope is coaxially disposed, a number of glass rods 405 to direct water flow, a water jacket 406 disposed between the inner and outer envelopes 402 and 404, a xenon atmosphere 408 disposed within the inner envelope, and a cathode 410 and anode 412 pair of short-arc electrodes disposed coaxially in the inner envelope, and also in the xenon atmosphere. A circulation of liquid, transparent coolant is maintained in the water jacket to cool the heat dissipated during operation by the cathode and anode short-arc pair of electrodes. A hot-mirror coating 414 is preferably applied to the outside surfaces of the quartz glass envelope 404 to suppress IR output.

The glass rods 405 help channel cooling water flow out to the distal end of the lamp. These help prevent short-path currents that don't contribute much to lamp cooling. Any number of other styles and kinds of water channeling can be used. The point is to get circulating water down to the distal end so as-uniform-as-possible cooling can progress all along the length and diameter of the lamp.

A pair of liquid-coolant supply 416 and return 418 ports are provided at the anode end of the water jacket near a stem 420 of the anode electrode. These are shown with straight in approaches that neck down to smaller diameters as they pass into the lamp. A longitudinally finned heat exchanger 422 receives circulating liquid coolant, and is coaxially disposed about the base stem 420.

A set of four bases 424-427 provided at each end of each of the inner and outer envelopes and providing for the separate containment of the water jacket 406 and the xenon atmosphere 408. Bases 424 and 425 are typically comprised of kovar and are fused to an inner envelope 402 of sapphire glass. The respective coefficients of thermal expansion are therefore closely matched and an appropriate seal can be maintained over the operational life of the lamp. Bases 426 and 427 are made of metal and are sealed with rubber O-rings against pressurized water leaks against the outer envelope 404 of quartz glass. Bases 424 and 426 are penetrated by a stem 428 of the cathode electrode. This provides for a first electrical connection 430 to operate the lamp. Conversely, bases 425 and 427 are penetrated by the anode stem 420, and this provides for a second electrical connection 432 to operate the lamp.

In order to reduce operational costs, it is preferable to construct lamp 400 such that the inner envelope 402 and all its working parts inside can be replaced as a single assembly, e.g., by remanufacturing. The bases 426 and 427 are therefore made to be removable by the factory from both the outer envelope 404 and the electrode stems 420 and 428.

The bare lamp assembly, comprising the inner sapphire glass envelope 402, the electrodes 410 and 412, and the kovar bases 424 and 425, is therefore preferably all bonded together. The stems 430 and 432 can be threaded so nuts or other fasteners can be used to retain the outside base ends 425 and 426 against the expansion pressures generated inside the water jacket 406. Lamp 400 can be scaled up and operated at high power levels, e.g., ten, fifteen, and twenty kilowatts.

In general, embodiments of the present invention exhibit very high heat transfer coefficients. This, without large water pressure increases that suppress boiling. The water jackets and channels are kept thin, and has relatively high flow rates, e.g., six GPM for the lamp.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A xenon arc lamp, comprising:
an inner hollow cylinder of glass;
an outer hollow cylinder of glass in which the inner cylinder is coaxially disposed;
a water jacket disposed between the inner and outer cylinders;
a xenon atmosphere disposed within the inner cylinder; and
a cathode and anode short-arc pair of electrodes disposed coaxially in the inner cylinder and also in the xenon atmosphere;
wherein, a circulation of liquid, transparent coolant in the water jacket cools any heat dissipated during operation by the cathode and anode short-arc pair of electrodes.

2. The lamp of claim 1, further comprising:
a mixture of deionized water and ethylene glycol disposed and able to circulate within the water jacket.

3. The lamp of claim 1, wherein:
the water jacket supports a pressurization of said coolant for preventing boiling.

4. The lamp of claim 1, further comprising:
a pair of liquid-coolant supply and return ports provided at one end of the water jacket near the anode electrode.

5. The lamp of claim 1, further comprising:
a finned heat exchanger through which any circulating liquid coolant must flow and coaxially disposed about a base stem of the anode electrode.

6. The lamp of claim 1, further comprising:
a set of four plugs one provided at each end of each of the inner and outer cylinders and providing for the separate containment of the water jacket and the xenon atmosphere.

7. The lamp of claim 6, wherein:
two of the plugs are penetrated by a stem of the cathode electrode that provides for a first electrical connection to operate the lamp; and
two remaining ones of the plugs are penetrated by a stem of the anode electrode that provides for a second electrical connection to operate the lamp.

8. The lamp of claim 1, further comprising:
a switch disposed to sense a flow of said coolant through the water jacket and able to interrupt operating power to the cathode and anode electrodes when a cooling failure occurs.

9. The lamp of claim 1, further comprising:
a reflector coaxially and externally disposed around the outer cylinder and including diffraction compensation for the peculiar bending of light that occurs at the inner and outer inner faces of the water jacket.

10. The lamp of claim 6, wherein:
the inner hollow cylinder of glass is substantially comprised of sapphire; and
the outer hollow cylinder of glass is substantially comprised of quartz quartz.

11. The lamp of claim 1, further comprising:
a channeling piece disposed within the water jacket to improve circulation of said coolant.
